(19) United States
(12) Patent Application Publication
(10) Pub. No.: US 2008/0278139 A1
(43) Pub. Date: Nov. 13, 2008

(54) SLEEP CURRENT ADJUSTING CIRCUIT OF SYSTEM ON CHIP

(75) Inventors: Yong Il Kwon, Suwon (KR); Myeung Su Kim, Suwon (KR); Joon Hyung Lim, Gunpo (KR); Koon Shik Cho, Suwon (KR); Tah Joon Park, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS., LTD., Suwon (KR)

(21) Appl. No.: 12/105,966

(22) Filed: Apr. 18, 2008

(30) Foreign Application Priority Data
May 7, 2007 (KR) 10-2007-0044255

(51) Int. Cl. H02M 3/156

(52) U.S. Cl. 323/351

(57) ABSTRACT

There is provided a sleep current adjusting circuit of a system on chip including: a regulator supplying a turn-on voltage and a normal current when a mode selection signal is a normal mode signal, and a turn-off voltage when the mode selection signal is a sleep mode signal; a switching device turned on by the turn-on voltage of the regulator to supply the normal current from the regulator to a main circuit part and a sleep operation circuit part, respectively, and turned off by the turn-off voltage of the regulator to block the normal current from being supplied to the main circuit part and supply the sleep current to the sleep operation circuit part; and a current limit device limiting an operating current flowing in response to the operating voltage and supplying the sleep current to the sleep operation circuit part.

### CROSS-REFERENCE TO RELATED APPLICATIONS

This application claims the priority of Korean Patent Application No. 2007-44255 filed on May 7, 2006, in the Korean Intellectual Property Office, the disclosure of which is incorporated herein by reference.

### BACKGROUND OF THE INVENTION

1. Field of the Invention

The present invention relates to a sleep current adjusting circuit applicable to a power apparatus of a system on chip (SoC), and more particularly, to a sleep current adjusting circuit of a SoC capable of adjusting a normal current and a sleep current required in the SoC accurately with a simplified configuration, thereby operating more stably.

2. Description of the Related Art

In general, a system on chip (SoC) is a technology-intensive semiconductor pertinent to wireless communication, in which a system with several functional parts such as a radio frequency (RF) circuit part, a modem part and a central processing unit (CPU) is implemented as one chip. Up to now, a wireless terminal has had communication modem function and computer function discretely. That is, several different processors perform functions for different purposes, and studies have been conducted competitively worldwide to integrate the system with several functions into one chip around year 2000.

As described above, the SoC denotes a technology-intensive semiconductor, in which several related functions are included in one chip, or a system (circuit) with several functions are integrated into one chip.

FIG. 1 is an explanatory view illustrating an operating current of a general system on chip.

Referring to FIG. 1, in the general system on chip, an operating current I1 may denote a current required for normal mode and a sleep current I2 may denote a current required for sleep mode. In this case, the system on chip includes a main circuit part 10 requiring the operating current I1 in the normal mode and not requiring a current in the sleep mode, and a sleep operation circuit part 20 requiring the operating current I1 in the normal mode and the sleep current I2 in the sleep mode.

Here, the operating current I1 is approximately tens of mA and the sleep current I2 is approximately several μA.

Also, the sleep operational circuit 20 may include a static random access memory (SRAM). The SRAM requires the operating current I1 of approximately 12 mA and the sleep current I2 of approximately 2 μA in the sleep mode.

One of conventional sleep current adjusting circuits adjusting such operating current I1 and sleep current I2 will be described with reference to FIG. 2.

FIG. 2 is a diagram illustrating a conventional sleep current adjusting circuit.

Referring to FIG. 2, the conventional sleep current adjusting circuit includes a first metal oxide semiconductor (MOS) transistor M1 connected between an operating voltage VDD and the sleep operation circuit 20 and a second MOS transistor M2 connected between the sleep operation circuit 20 and a ground.

The first and second MOS transistors M1 and M2 each have an internal resistance varied by a sleep mode voltage Vsleep to thereby adjust a current.

For example, increase in the sleep mode voltage Vsleep reduces the internal resistance of the first and second MOS transistors M1 and M2, respectively and thus results in a high operating current. Meanwhile, decrease in the sleep mode voltage Vsleep increases the internal resistance of the first and second MOS transistors M1 and M2, respectively and thus results in a low sleep current.

In the conventional sleep current adjusting circuit shown in FIG. 1, the resistance is adjusted using the voltage to eventually adjust the current. This renders the current hardly adjustable with accuracy and thus does not ensure stable operation of the circuit.

### SUMMARY OF THE INVENTION

An aspect of the present invention provides a sleep current adjusting circuit of a system on chip (SoC) capable of adjusting a normal current and a sleep current required in the system on chip accurately with a simplified configuration, thereby operating more stably.

According to an aspect of the present invention, there is provided a sleep current adjusting circuit of a system on chip having a main circuit part requiring a normal current and a sleep operation circuit part requiring the normal current and a sleep current, the sleep current adjusting circuit including: a regulator supplying a turn-on voltage and the normal current when a mode selection signal is a normal mode signal, and a turn-off voltage when the mode selection signal is a sleep mode signal; a switching device connected between a connecting node connected to a current input terminal of the sleep operation circuit part and an output terminal of the regulator, the switching device turned on by the turn-on voltage of the regulator to supply the normal current from the regulator to the main circuit part and the sleep operation circuit part, respectively, and turned off by the turn-off voltage of the regulator to block the normal current from being supplied to the main circuit part and supply the sleep current to the sleep operation circuit part; and a current limit device connected between an operating voltage terminal and the switching device, the current limit device limiting an operating current flowing in response to the operating voltage and supplying the sleep current to the sleep operation circuit part.

The switching device may be formed of a diode having an anode connected to the output terminal of the regulator and a cathode connected to the connecting node.

The current limit device may include a resistor having a resistance limiting the operating current to the sleep current required by the sleep operation circuit part.

The diode may be turned on by the turn-on voltage of the regulator to supply the normal current from the regulator to the main circuit part and the sleep operation circuit part, respectively, and turned off by the turn-off voltage of the regulator to block the current from being supplied to the main circuit part and supply the sleep current to the sleep operation circuit part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an explanatory view illustrating an operating current of a system on chip;

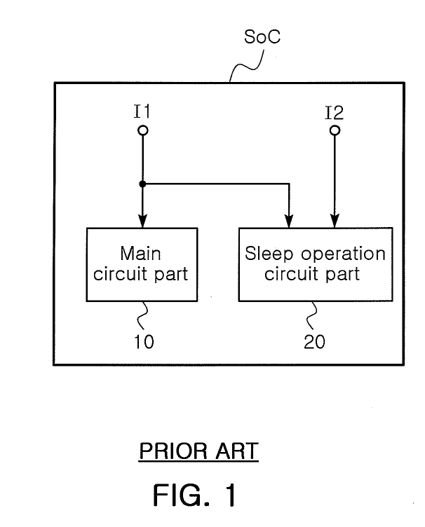

FIG. 2 is a diagram illustrating a conventional sleep current adjusting circuit; and

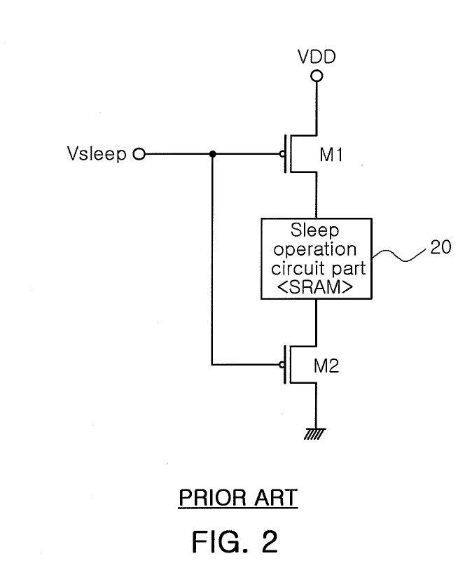

FIG. 3 is a diagram illustrating a sleep current adjusting circuit according to an exemplary embodiment of the invention.

### DETAILED DESCRIPTION OF THE PREFERRED EMBODIMENT

Exemplary embodiments of the present invention will now be described in detail with reference to the accompanying drawings. It is intended, however, that the embodiments shall be interpreted as illustrative only, but various variations and modifications can be made without departing from the scope of the invention. In the drawings, the shapes and dimensions may be exaggerated for clarity, and the same reference signs are used to designate the same or similar components throughout.

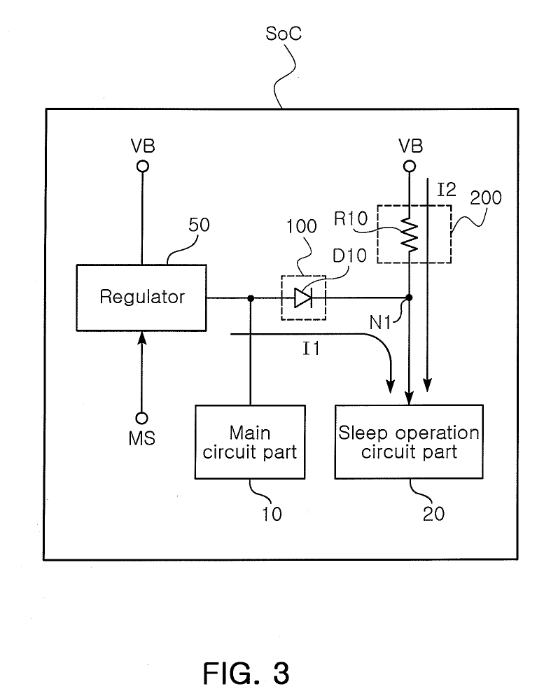

FIG. 3 is a diagram illustrating a sleep current adjusting circuit according to an exemplary embodiment of the invention.

Referring to FIG. 3, the sleep current adjusting circuit of the present embodiment is applied to a system on chip including a main circuit part 10 requiring a normal current I1 and a sleep operation circuit part 20 requiring the normal current I1 and a sleep current I2.

The sleep current adjusting circuit includes a regulator 50, a switching device 100 and a current limit device 200. The regulator 50 supplies a turn-on voltage and the normal current I1 when normal mode is selected, that is, a mode selection signal MS is a normal mode signal, and a turn-off voltage when sleep mode is selected, that is, the mode selection signal MS is a sleep mode signal.

The switching device 100 is connected between a connecting node N1 connected to a current input terminal of the sleep operation circuit part 20 and an output terminal of the regulator 50. The switching device 100 is turned on by the turn-on voltage of the regulator 50 to supply the normal current I1 from the regulator 50 to the main circuit part 10 and the sleep operation circuit part 20, respectively. Also, the switching device 100 is turned off by the turn-off voltage of the regulator 50 to block the normal current from flowing to the main circuit part 10 and supply a sleep current I2 to the sleep operation circuit part 20 as described below.

That is, the current limit device 200 is connected between an operating voltage VB terminal and the switching device 100. The current limit device 200 limits an operating current flowing in response to the operating voltage VB and supplies the sleep current I2 to the sleep operation circuit part 20.

The switching device 100 may be formed of a diode D10 having an anode connected to the output terminal of the regulator 50 and a cathode connected to the connecting node N1.

Specifically, the diode D10 is turned on by the turn-on voltage of the regulator 50 to supply the normal current I1 from the regulator 50 to the main circuit part 10 and the sleep operation circuit part 20, respectively and turned off by the turn-off voltage of the regulator 50 to block the normal current I1 from being supplied.

The current limit device 200 includes a resistor R10 having a resistance limiting the current to the sleep current I2 required by the sleep operation circuit part 20.

Hereinafter, operation and effects of the present embodiment will be described in detail.

Referring to FIG. 3, the sleep current adjusting circuit of the present embodiment is applied to the system on chip including the main circuit 10 requiring the normal current I1 and the sleep operation circuit part 20 requiring the normal current I1 and the sleep current I2. The sleep current adjusting circuit adjusts the normal current I1 and the sleep current I2.

That is, in the system on chip (SoC) to which the sleep current adjusting circuit of the present invention is applied, the sleep current adjusting circuit supplies the normal current I1 in normal mode, and the sleep current I2 in sleep mode. This will be described in detail below.

First, the sleep current adjusting circuit includes the regulator 50, the switching device 100 and the current limit device 200.

The regulator 50 supplies the turn-on voltage for turning on the switching device 100 and the normal current I1 to the switching device 100 when the mode selection signal MS is the normal mode signal. Here, the mode selection signal MS can be determined manually or automatically.

At this time, the switching device 100 is turned on by the turn-on voltage from the regulator 50 to supply the normal current I1 from the regulator 50 to the main circuit part 10 and the sleep operation circuit part 20, respectively.

On the other hand, in the system on chip according to the present embodiment, when the sleep mode is selected to save power, the mode selection signal MS becomes the sleep mode signal. Then, the regulator 50 supplies the turn-off voltage to the switching device 100 to turn off the switching device 100.

Specifically, as shown in FIG. 3, in a case where the switching device 100 is formed of the diode D10, first, in the normal mode, when the diode D10 is turned on by the turn-on voltage of the regulator 50, the normal current I1 from the regulator 50 is supplied to the main circuit part 10, and the sleep operation circuit part 20 as well through the diode D10.

On the other hand, in the sleep mode, when the diode d10 is turned off by the turn-off voltage of the regulator 50, the sleep current I2 limited by the current limit device 200, i.e., the resistor R10 is supplied to the sleep operation circuit part 20. Also, the sleep current is not supplied to the main circuit part 10 due to the switching device 100 which is in an OFF state. That is, the sleep current is blocked by the switching device 100.

At the same time, the switching device 100, i.e., the diode D10 is in an OFF state. Thus, the normal current, even though generated from the regulator 50 is blocked by the switching device 100 from being supplied to the sleep operation circuit part 20.

Meanwhile, when the switching device 100 is in an ON state, as described above, the normal current I1 is supplied to the main circuit part 10 and the sleep operation circuit part 20, respectively through the switching device 100. Accordingly the current limited by the current limit device 200 is relatively much smaller than the normal current I1 and thus combined with the normal current I1 to be supplied to the sleep operation circuit part 20.

When the switching device 100 is in an OFF state, the current flowing in response to the operating voltage VB is limited by the current limit device 200 and thus the sleep current I2 supplied through the current limit device 200 is supplied to the sleep operation circuit part 20.

As described above, in the present embodiment, the normal current and the sleep current can be adjustably supplied according to operation mode without employing a transistor.

As set forth above, a sleep current adjusting circuit of a SoC according to exemplary embodiments of the invention can adjust a normal current and a sleep current required in a system on chip accurately with a simplified configuration, thereby operating more stably.

While the present invention has been shown and described in connection with the exemplary embodiments, it will be apparent to those skilled in the art that modifications and variations can be made without departing from the spirit and scope of the invention as defined by the appended claims.

What is claimed is:

1. A sleep current adjusting circuit of a system on chip having a main circuit part requiring a normal current and a sleep operation circuit part requiring the normal current and a sleep current, the sleep current adjusting circuit comprising:
a regulator supplying a turn-on voltage and the normal current when a mode selection signal is a normal mode signal, and a turn-off voltage when the mode selection signal is a sleep mode signal;
a switching device connected between a connecting node connected to a current input terminal of the sleep operation circuit part and an output terminal of the regulator, the switching device turned on by the turn-on voltage of the regulator to supply the normal current from the regulator to the main circuit part and the sleep operation circuit part, respectively, and turned off by the turn-off voltage of the regulator to block the normal current from being supplied to the main circuit part and supply the sleep current to the sleep operation circuit part; and
a current limit device connected between an operating voltage terminal and the switching device, the current limit device limiting an operating current flowing in response to the operating voltage and supplying the sleep current to the sleep operation circuit part.

2. The sleep current adjusting circuit of a system on chip of claim 1, wherein the switching device is formed of a diode having an anode connected to the output terminal of the regulator and a cathode connected to the connecting node.

3. The sleep current adjusting circuit of a system on chip of claim 2, wherein the current limit device comprises a resistor having a resistance limiting the operating current to the sleep current required by the sleep operation circuit part.

4. The sleep current adjusting circuit of a system on chip of claim 2, wherein the diode is turned on by the turn-on voltage of the regulator to supply the normal current from the regulator to the main circuit part and the sleep operation circuit part, respectively, and turned off by the turn-off voltage of the regulator to block the current from being supplied to the main circuit part and supply the sleep current to the sleep operation circuit part.
